(19) United States
(12) Patent Application Publication
(10) Pub. No.: US 2024/0362595 A1
(43) Pub. Date: Oct. 31, 2024

(54) METHOD AND SYSTEM FOR DETERMINING SERVICE PROVIDER APPOINTMENTS

(71) Applicant: Remark Visions LLC, Capistrano Beach, CA (US)

(72) Inventor: Mark Alexander Gustafson, Capistrano Beach, CA (US)

(21) Appl. No.: 18/646,419

(22) Filed: Apr. 25, 2024

Related U.S. Application Data
(60) Provisional application No. 63/498,293, filed on Apr. 26, 2023.

(51) Int. Cl. G06Q 10/1093; H04L 51/02

(52) U.S. Cl. CPC G06Q 10/1095; H04L 51/02

(57) ABSTRACT

A method of determining service provider appointments is provided. The method can include providing, by a data processor of a multi-provider scheduling platform, at least one conversational agent configured to receive query inputs and generate response outputs associated with scheduling target assignments performed by at least one service provider. First data characterizing a query input provided to the at least one conversational agent can be received. The query input can include a request for at least one service provider to perform target assignment at a target assignment time. Second data characterizing a response output contextually relevant to the query input can be determined. The response output can include one or more appointments corresponding to the target assignment and the target assignment time and the response output including the one or more appointments can be provided to the conversational agent. Related systems and computer program products are also provided.

### CROSS-REFERENCE TO RELATED APPLICATIONS

This application claims priority under 35 U.S.C. § 119 to U.S. Provisional Patent Application No. 63/498,293 filed Apr. 26, 2023, entitled “Method and System For Automatically Scheduling Service Provider Appointment At A Target Location” which is hereby incorporated herein by reference in its entirety.

### BACKGROUND

This disclosure relates generally to the technical field of calendar scheduling. In particular, the disclosure relates to identifying service providers for performing a target assignment based on a calendar schedule. Calendaring software can include an electronic version of a calendar associated with an individual or an organization. The calendaring software can include location, address book, time zone, contact list, etc. associated with an individual (e.g., a service provider). In some implementations, the calendaring software can be configured to communicate with an external program via an application programming interface (API). For example, the calendaring software can request various information associated with the individual (e.g., calendar schedule, location, etc.) from the external program. In some implementations, the calendaring software can be a web application that can allow one or more pre-approved users to access information therein.

### SUMMARY

Various aspects of the disclosed subject matter may provide one or more of the following capabilities.

In one aspect, a method is provided. In one embodiment, the method can include providing, by a data processor of a multi-provider scheduling platform, at least one conversational agent configured to receive query inputs and generate response outputs associated with scheduling target assignments performed by at least one service provider. The method can also include receiving, by the data processor, first data characterizing a query input provided to the at least one conversational agent. The query input can include a request for at least one service provider to perform target assignment at a target assignment time. The method can further include determining, by the data processor, second data characterizing a response output contextually relevant to the query input. The response output can include one or more appointments corresponding to the target assignment and the target assignment time. The method can also include providing, by the data processor, the response output including the one or more appointments to the conversational agent.

In some embodiments, the conversational agent can include a natural language interface configured to receive the query inputs and generate the response outputs in audible format. In some embodiments, the multi-provider scheduling platform can include a plurality of conversational agents. Each conversational agent can be associated with a respective service provider of a plurality of service providers configured in the multi-provider scheduling platform and can be configured to generate contextually relevant response outputs based on the respective service provider and the query input. In some embodiments, the at least one conversational agent can be configured to generate response outputs based on a predictive model associated with the at least one service provider. The predictive model can be trained in a machine learning process using training data including one or more of target assignment types performed by the at least one service provider, schedule data associated with the at least one service provider, and resources associated with the at least one service provider.

In some embodiments, determining the response output can further include determining the one or more appointments based on an appointment score determined for respective appointments of the one or more appointments. The appointment score can be determined based at least on a first ratio of a travel time before the respective appointment and a travel time after the respective appointment and a second ratio of a travel distance before the respective appointment and a travel distance after the respective appointment, and the method can further include providing the response output including a ranked list of the one or more appointments based on the determined appointment score. In some embodiments, determining the appointment score can further include determining a weighted efficiency score for respective appointments of the one or more appointments. The weighted efficiency score can be determined based on a combined travel time for the respective appointment compared to a combined travel time for a second appointment of the one or more appointments. The weighted efficiency score can further be determined based on a combined travel factor provided by the at least one service provider and can be configured to prioritize the respective appointment having a lower combined travel time compared to the second appointment.

In some embodiments, determining the response output can further include determining the one or more appointments based on an anchor parameter defining a window of time between a start time or an end time in which the one or more appointments can be scheduled and for which an amount of downtime before or after the one or more appointments is minimized. In some embodiments, the anchor parameter can correspond to a blocking event, a non-blocking event, a daily start time, a daily end time, or a previously scheduled appointment. In some embodiments, determining the response output can further include determining the one or more appointments based on the anchor parameter and a suitability factor corresponding to a likelihood the respective appointment will occur within the window of time defined by the anchor parameter. In some embodiments, the suitability factor can be determined as a function of an amount of time a portion of the respective appointment will occur outside the window of time defined by the anchor parameter and a combined travel time for the respective appointment compared to a combined travel time for a second appointment of the one or more appointments.

In another aspect, a system is provided and in one embodiment, the system can include at least one data processor of a multi-provider scheduling platform. The system can also include a memory coupled to the at least one data processor. The memory can store instructions to cause the at least one data processor to perform operations comprising providing at least one conversational agent configured to receive query inputs and generate response outputs associated with scheduling target assignments performed by at least one service provider. The operations can also include receiving first data characterizing a query input provided to the at least one conversational agent. The query input can include a request for at least one service provider to perform target assignment at a target assignment time. The operations can also include determining second data characterizing a response output contextually relevant to the query input. The response output can include one or more appointments corresponding to the target assignment and the target assignment time. The operations can further include providing the response output including the one or more appointments to the conversational agent.

In some embodiments, the conversational agent can include a natural language interface configured to receive the query inputs and generate the response outputs in audible format. In some embodiments, the multi-provider scheduling platform can include a plurality of conversational agents. Each conversational agent can be associated with a respective service provider of a plurality of service providers configured in the multi-provider scheduling platform and can be configured to generate contextually relevant response outputs based on the respective service provider and the query input. In some embodiments, the at least one conversational agent can be configured to generate response outputs based on a predictive model associated with the at least one service provider. The predictive model can be trained in a machine learning process using training data including one or more of target assignment types performed by the at least one service provider, schedule data associated with the at least one service provider, and resources associated with the at least one service provider.

In some embodiments, determining the response output can further include determining the one or more appointments based on an appointment score determined for respective appointments of the one or more appointments. The appointment score can be determined based at least on a first ratio of a travel time before the respective appointment and a travel time after the respective appointment and a second ratio of a travel distance before the respective appointment and a travel distance after the respective appointment, and the operations can further include providing the response output including a ranked list of the one or more appointments based on the determined appointment score. In some embodiments, determining the appointment score can further include determining a weighted efficiency score for respective appointments of the one or more appointments. The weighted efficiency score can be determined based on a combined travel time for the respective appointment compared to a combined travel time for a second appointment of the one or more appointments. The weighted efficiency score can further be determined based on a combined travel factor provided by the at least one service provider and can be configured to prioritize the respective appointment having a lower combined travel time compared to the second appointment.

In some embodiments, determining the response output can further include determining the one or more appointments based on an anchor parameter defining a window of time between a start time or an end time in which the one or more appointments can be scheduled and for which an amount of downtime before or after the one or more appointments is minimized. In some embodiments, the anchor parameter can correspond to a blocking event, a non-blocking event, a daily start time, a daily end time, or a previously scheduled appointment. In some embodiments, determining the response output can further include determining the one or more appointments based on the anchor parameter and a suitability factor corresponding to a likelihood the respective appointment will occur within the window of time defined by the anchor parameter. In some embodiments, the suitability factor can be determined as a function of an amount of time a portion of the respective appointment will occur outside the window of time defined by the anchor parameter and a combined travel time for the respective appointment compared to a combined travel time for a second appointment of the one or more appointments.

These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings.

FIG. 1 is a flow chart of an exemplary method for scheduling a service appointment;

FIG. 2 illustrates an exemplary operation of the scheduling service;

FIG. 3 is an exemplary illustration of a proposed comprehensive operation time for an available time slot in a service provider's calendar schedule;

FIG. 4 is an exemplary illustration of multiple proposals for comprehensive operation times for an available time slot in a service provider's calendar schedule;

FIG. 5 is an exemplary illustration of a proposed comprehensive operation time that includes travel buffer time;

FIG. 6 illustrates an exemplary schematic for determination of estimated travel fee associated with a travel time;

FIG. 7 is an exemplary illustration of a proposed operation time having a time duration greater than a time slot;

FIG. 8 is an exemplary illustration of a proposed comprehensive operation time having a time duration greater than a time slot;

FIG. 9 is an exemplary illustration of multiple proposals for comprehensive operation times for an available time slot;

FIG. 10 illustrates exemplary selection of service providers for a target location 1000 based on maximum travelling distances;

FIG. 11 illustrates an exemplary computation device for scheduling a service appointment;

FIG. 12 illustrates a first set of proposed appointments generated using the system and methods described herein;

FIG. 13 illustrates a table of data used to determine an appointment score (AS) for the proposed appointments of FIG. 12;

FIG. 14 illustrates a second set of proposed appointments generated using the system and methods described herein;

FIG. 15 illustrates proposed anchor parameters and preferred windows for the proposed appointments of FIG. 14;

FIG. 16 illustrates the proposed appointment of FIG. 14 ranked according to the system and methods herein based on the proposed anchor parameters and preferred windows of FIG. 15;

FIG. 17 illustrates a table of data used to determine an AS for the proposed appointments of FIG. 14; and

FIG. 18 illustrates a table of data used to determine an AS and a weighted efficiency score (WES) for the proposed appointments of FIG. 12 based on the system and methods herein.

### DETAILED DESCRIPTION

Scheduling a service appointment by a user to perform a target assignment can depend on multiple factors (e.g., type and location of target assignment, availability of service providers, etc.). This can be a challenging task. For example, in order to schedule a service appointment, the user may have to identify the potential service providers that are capable of performing the target assignment, contact the identified service providers (e.g., via phone, email, etc.) and determine their availability to complete the target assignment. Scheduling an appointment by identifying potential service providers and contacting them individually can be challenging, cumbersome and inefficient. For example, the user may not have access to the electronic calendar of the service providers, and as a result may contact service providers that are unavailable or prefer not to perform the target assignment (e.g., based on service provider preferences). Even if the user can access the electronic calendars of the service providers (e.g., via a third party repository of service providers' electronic calendar), the user may not be able to identify service providers suitable for the target assignment (e.g., the location of the target assignment may be outside service provider's preferred service area, cost of hiring the service provider may be greater than the user's budget, etc.).

Some implementations of the current subject matter allows for identification of service providers capable of performing a target assignment based on availability of the service providers, service provider preferences (e.g., maximum travel distance or maximum travel time preferred by the service provider), and user preferences (e.g., type and location of target assignment, target assignment area, etc.). The availability of a service provider can be based on available time slots (e.g., identified from the service provider's electronic calendar), travel time to and from the target location. In some implementations, the target assignment budget for a given service provider (e.g., selected from the available service providers) can be determined based on the predetermined cost associated with the target assignment, target assignment area and travel time/distance of the service provider to perform the target assignment.

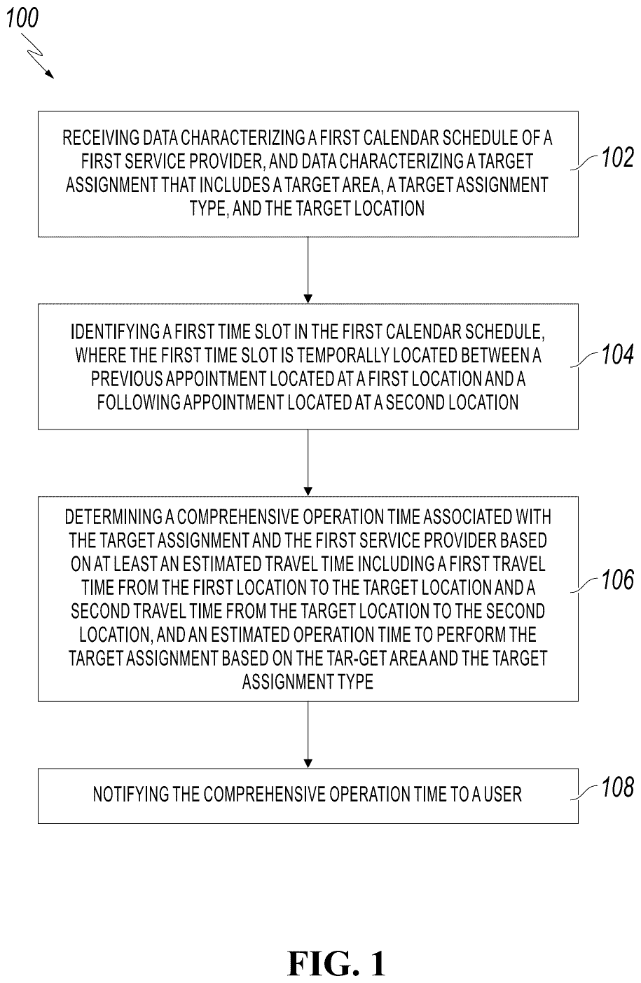

FIG. 1 a flow chart of an exemplary method for scheduling a service appointment. At 102, data characterizing a first calendar schedule of a first service provider and data characterizing a target assignment that includes a target area (e.g., area of the property associated with the target assignment), a target assignment type, and the target location is received (e.g., by a processor of a computing device). In some implementation, the first calendar schedule can be retrieved (e.g., automatically) from the electronic calendar of the first service provider. The first calendar schedule can include the time, duration, and location of the various appointments associated with the first service provider. Information associated with the target assignment (e.g., target area, target assignment type, target location, etc.) can be provided by user (e.g., when the user is attempting to schedule an appointment).

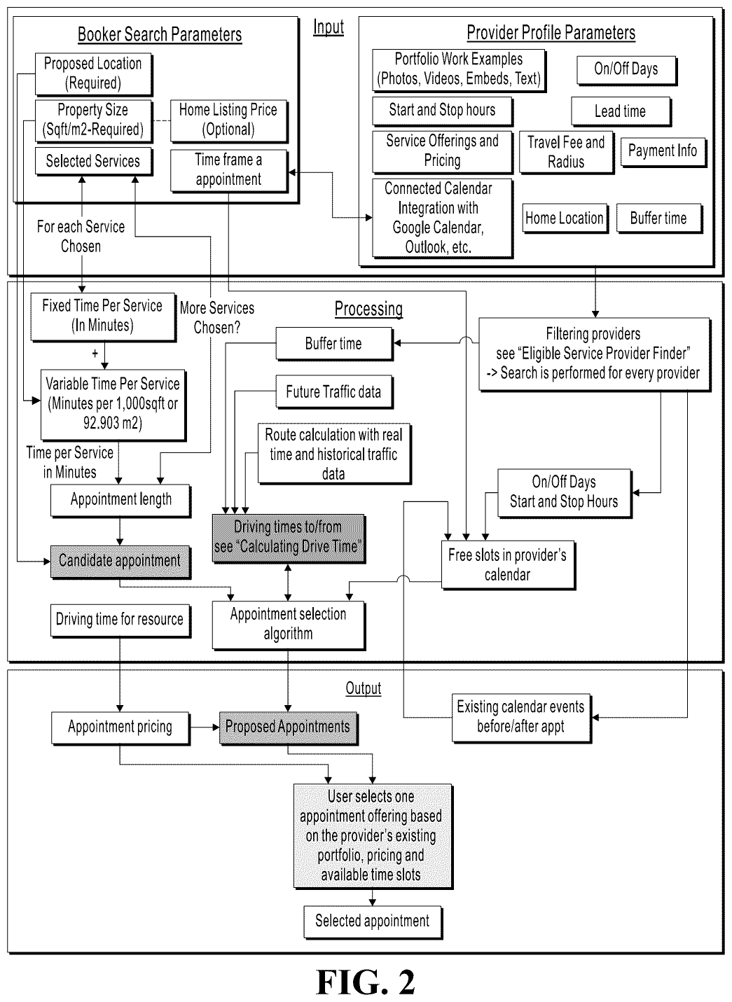

FIG. 2 illustrates an exemplary operation of the scheduling service. The scheduling service receives inputs that can include information provided by the user (also referred to as the booker) that can include one or more of address of the target location, a property size associated with the target location, a target assignment type, a timeframe for scheduling the target assignment, and listed price of the target location. The inputs can include service preferences provided by the service provider. For example, the service preferences can include one or more of a home location, a preferred distance/time of travel (e.g., a maximum distance/time of travel from a predetermined location [e.g., home location]) to provide a service, operation cost (e.g., travel cost, cost of performing the target assignment, etc.), a buffer time to be added to the overall travel time, service offering and pricing, operating scheduling (e.g., on/off days, start and stop hours, etc.), a professional portfolio with examples (e.g., photos, videos, embeds, text, etc.) of professional work, data associated with the service provider's electronic calendar, etc.

Based on the inputs, the scheduling service can calculate recommendations for proposed appointments with one or more service providers. Additionally, the recommendations can include the time and duration of the proposed appointment and the corresponding operation cost associated with the proposed appointments. Current subject matter describes exemplary methods for calculating the proposed appointments.

In some implementations, data characterizing calendar schedules and service preferences associated with a plurality of service providers can be received and the first service provider can be selected from the plurality of service providers. For example, the first service provider can be selected from the plurality of service providers based on a first set of service preferences associated with the first service provider (e.g., service preferences received at step 102). The service preferences can include at least one of a maximum travel time, a maximum travel distance, an operation cost, or an operating schedule associated with the first service provider. In some implementations, the service preferences can include target assignment type (e.g., indicative of the work the target assignment entails).

Returning back to FIG. 1, at step 104, a first time slot in the first calendar schedule can be identified. The first calendar schedule received at step 102 can include multiple available time slots. A given time slot (e.g., first time slot) can be defined as being temporally located between a previous appointment and a following appointment. The previous appointment can be associated with a first location and the following appointment can be associated with a second location. In some implementations, the first appointment can be defined as a start from home (e.g. at the beginning of the work day) and the first location can be the home address. In some implementations, the second appointment can be defined as a return to home (e.g. at the end of the work day) and the second location is the home address.

In some implementations, a service provider (e.g., first service provider) can be selected from the plurality of service providers only if the distance between a predetermined location (e.g., home location, first location of the previous appointment, second location of the following appointment, etc.) and the target location is less than the maximum travel distance preferred by the service provider and/or if the time of travel to the target location (e.g., from the first location, home location, etc.) and from the target location (e.g., to the second location, home location, etc.) is less than a maximum travel time. The maximum travel distance/time can be included in the service preferences provided by the service provider. In some implementations, a service provider (e.g., first service provider) can set the service provider settings that can allow for usage of the current location of the service provider (e.g., determined using GPS) as the predetermined location from where various travel attributes (e.g., travel time, travel distance, etc.) to the target location are calculated. For example, when the user is booking the services of the service provider on the day of the target assignment, various travel attributes can be calculated based on the current location (e.g., instead of the home location).

Returning back to FIG. 1, at step 106, an estimate of a comprehensive operation time that may be taken by the first service provider to perform the target assignment can be determined. The comprehensive operation time can include an estimated travel time (e.g., which includes first travel time from the first location to the target location and a second travel time from the target location to the second location), and an estimated operation time to perform the target assignment. In some implementations, the estimated operation time can include a base operation time and a target-area-based operation time. The base operation time can be indicative of the time taken to set up the equipment for performing the target assignment. The based operation time can be based on the target assignment type. The target based operation time can be calculated by multiplying the square footage of the target location with a predetermined time per unit target area for performing the target assignment.

In some implementations, a given target site can include multiple target assignments. For example, a target site with a given target area can include multiple target assignments (e.g., a first target assignment, a second target assignment, a third target assignment and a fourth target assignment). Each of the target assignment can be associated with a corresponding base operation time (or fixed time) and a target-area-based operation time. As described above, estimated operation time can be calculated for each of the assignment (e.g., estimated operation time=base operation time+target-are-based operation time*target area). A total estimated operation time can be the sum of each of the estimated operation time (associated with the multiple assignments).

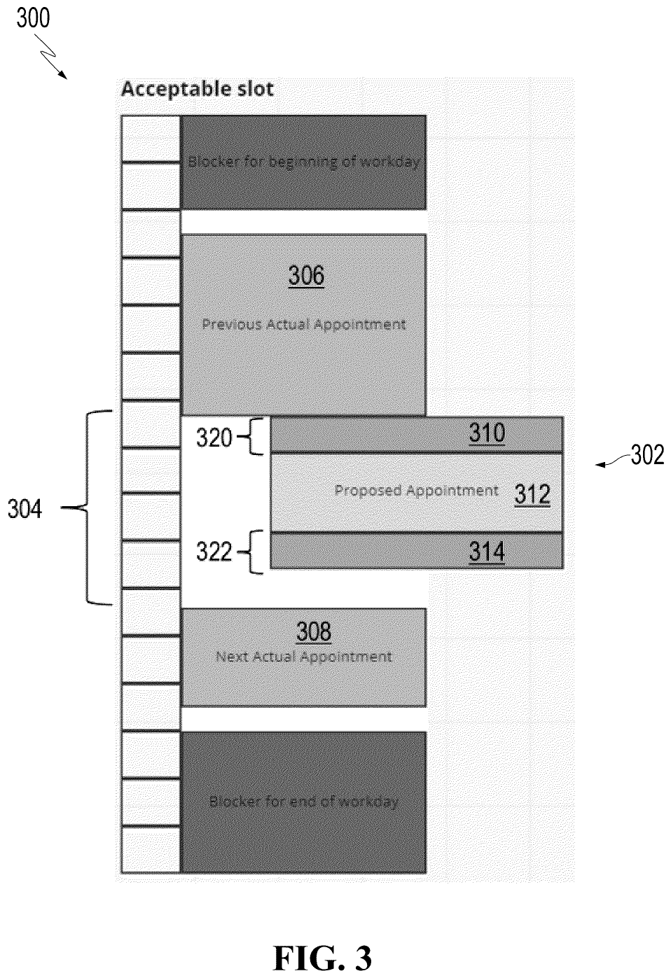

The estimation for the time taken to travel to the target location prior to the target assignment (e.g., the first travel time) and from the target location after the target assignment is completed (e.g., second travel time) can be estimated based on historical Global Positioning System (GPS) data. FIG. 3 is an exemplary illustration of a proposed comprehensive operation time for an available time slot in a service provider's calendar schedule. FIG. 3 illustrates that a comprehensive operation time 302 can be scheduled in the time slot 304 temporally located between a previous appointment 306 and a following appointment 308. The comprehensive operation time 302 includes a first travel time 310, an estimated operation time 312 and a second travel time 314. The first travel time 310 can be calculated based on historical GPS data (e.g., historical traffic data) for travelling from the first location of the previous appointment 306 to the target location at during a first portion 320 of the time slot 304. In some implementations, a forecasted traffic data can be used to calculate the first travel time 310. In some implementations, the forecasted traffic data can be calculated based on historical traffic data.

In some implementations, the first travel time 310 can be calculated by setting the temporal end of the previous appointment 306 as the beginning of the first travel time 310 time (or “depart by this time”). The second travel time 314 can be calculated based on historical GPS data for travelling from the target location to the second location of the following appointment 308 during a second portion 322 of the time slot 304. In some implementations, the second travel 314 time can be calculated by setting the temporal end of the proposed appointment 312 as the beginning of the second travel 314 (or “depart by this time”).

In some implementations, the first travel time 310 can be calculated by setting the temporal beginning of estimated operation time 312 as the end of the first travel time 310 (or “arrive by this time”). The second travel time 314 can be calculated based on historical GPS data for travelling from the target location to the second location of the following appointment 308 during a second portion 322 of the time slot 304. In some implementations, the second travel 314 time can be calculated by setting the temporal beginning of the following appointment 308 as the end of the second travel 314 (or “arrive by this time”).

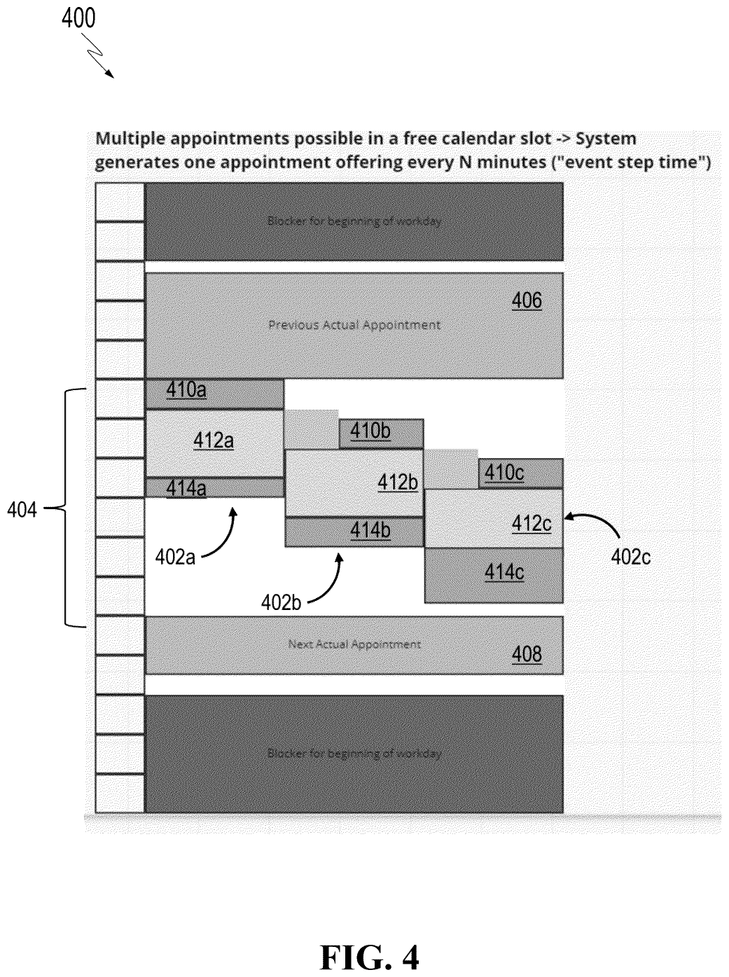

In some implementations, multiple proposed comprehensive operation times can be calculated for a given time slot. FIG. 4 is an exemplary illustration of multiple proposals for comprehensive operation times for an available time slot in a service provider's calendar schedule. FIG. 4 illustrates that proposals of comprehensive operation times 402a, 402b and 402c can be scheduled in the time slot 404 temporally located between a previous appointment 406 and a following appointment 408. The proposals of comprehensive operation times 402a, 402b and 402c can be temporally separated by a step time 416. In other words, if two proposals of comprehension operation times are made in a given time slot, the proposed comprehensive operation times can be separated by at least a step time (e.g., step time 416). The step time can be defined in service provider preferences. The comprehensive operation time 402a includes a first travel time 410a, an estimated operation time 412a and a second travel time 414a. The comprehensive operation time 402b includes a first travel time 410b, an estimated operation time 412b and a second travel time 414b. The comprehensive operation time 402c includes a first travel time 410c, an estimated operation time 412c and a second travel time 414c. Since the travel time associated with the different operation times occurs at different portions of the time slot 404, the travel time (e.g., travel time to the target location, travel time from the target location, etc.) can vary. In some implementations, the user can select the comprehensive operation time that corresponds to the smallest travel time.

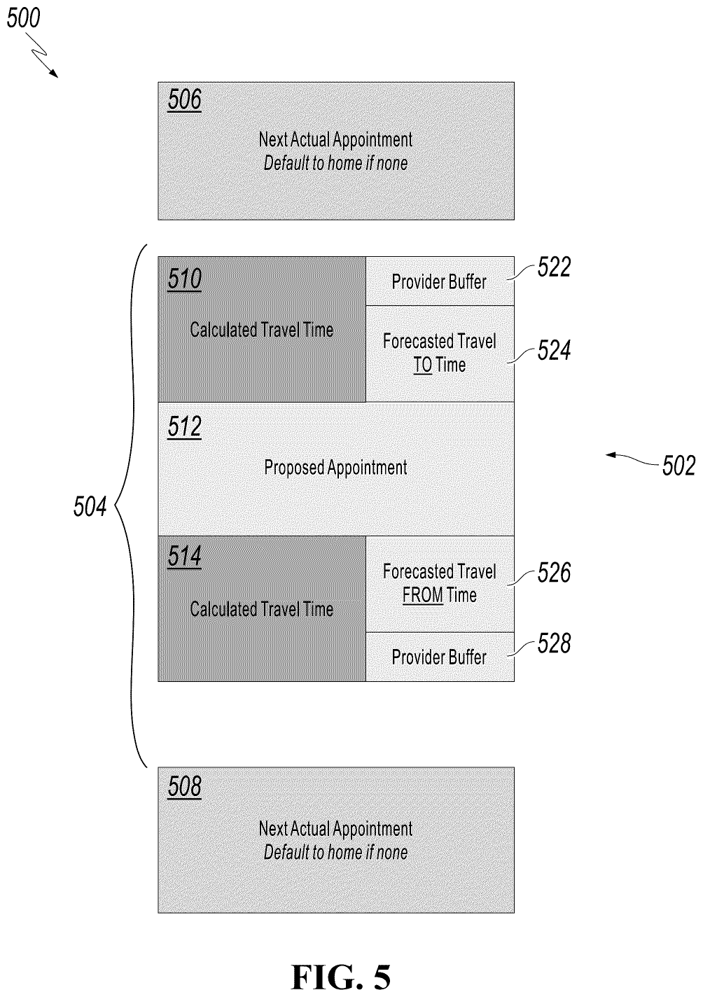

In some implementations, the comprehensive operation time can include travel buffer time that can be included in the service preferences provided by the first service provider. FIG. 5 is an exemplary illustration of a comprehensive operation time that includes travel buffer time. FIG. 5 illustrates that a proposed comprehensive operation time 502 can be scheduled in the time slot 504 temporally located between a previous appointment 506 and a following appointment 508. The comprehensive operation time 502 includes a first total travel time 510, an estimated operation time 512 and a second total travel time 514. The first total travel time 510 includes a first travel buffer time 522 (e.g., included in the service preferences) and a first travel time 524 (e.g., determined from GPS traffic data). The second total travel time 514 includes a second travel buffer time 528 (e.g., included in the service preferences) and a second travel time 524 (e.g., determined from GPS traffic data).

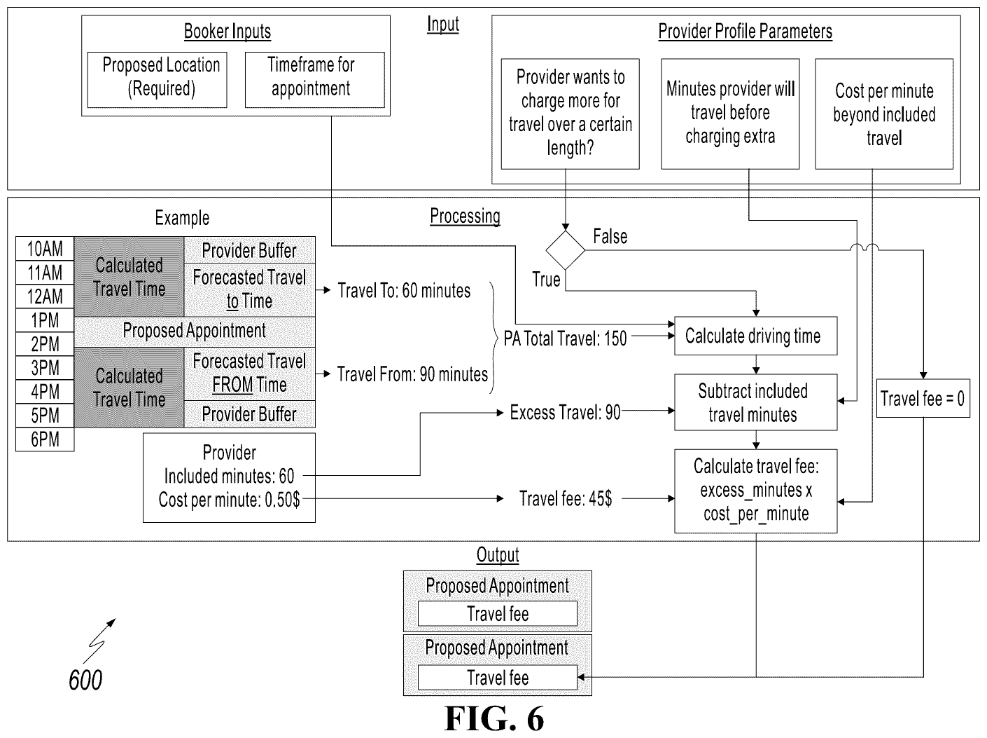

In some implementations, an operation cost associated with performing the target assignment can be determined. The determination of operation cost can be based on one or more of the estimated travel time, the estimated operation time, the target area, or the comprehensive operation time. FIG. 6 illustrates an exemplary schematic for determination of estimated travel fee associated with a travel time. The inputs for the travel fee determination algorithm can include information associated with the target assignment provided by the user (e.g., target location, a timeframe for performing the target assignment, etc.) and service preferences provided by the service provider (e.g., a threshold time below which no travel fee will be charged, travel cost per unit time (e.g., above the threshold time), travel fee brackets as a function of travel time, etc.). The travel fee calculation can include determination of the total travel time (e.g., time from the first location to the target location and time from the target location to the second location). In some implementations, a difference between the total travel time and the threshold time (e.g., indicative of free travel time) can be calculated, and the difference can be multiplied by the travel cost per unit time (e.g., provided by the service provider) to determine the travel fec.

In some implementations, the determination of operation cost can further include calculating a product of the target area (e.g., provided by the user) and the cost per unit target area (e.g., included in the service preferences of the service provider). In some implementation, the area based operating cost can be added to one or more of a base operating cost for performing the target assignment (e.g., included in the service preferences of the service provider) and the calculated travel fee to determine the overall operation cost.

Steps 102-106 can be repeated for multiple service providers (e.g., service providers selected from a plurality of service providers as discussed above), and comprehensive operation time and/or operation cost can be calculated for multiple service providers. Returning back to FIG. 1, at step 108, user can be notified with the information associated with the comprehensive operation time (e.g., as determined at step 106) and/or operation cost for one or more service providers. For example, the operation time and operation cost of the first service provider can be provided to the user. In some implementations, the user can get a notification that can include the length of the appointment (e.g., service provider's tentative time of arrival to and departure from the target location). In some implementations, the user can be provided with the basis of the calculation of travel fee (e.g., e.g., travel fee rates). In some implementations, the user may be notified of the estimated operation time rather than the comprehensive operation time (e.g., the estimated travel time may not be provided to the user).

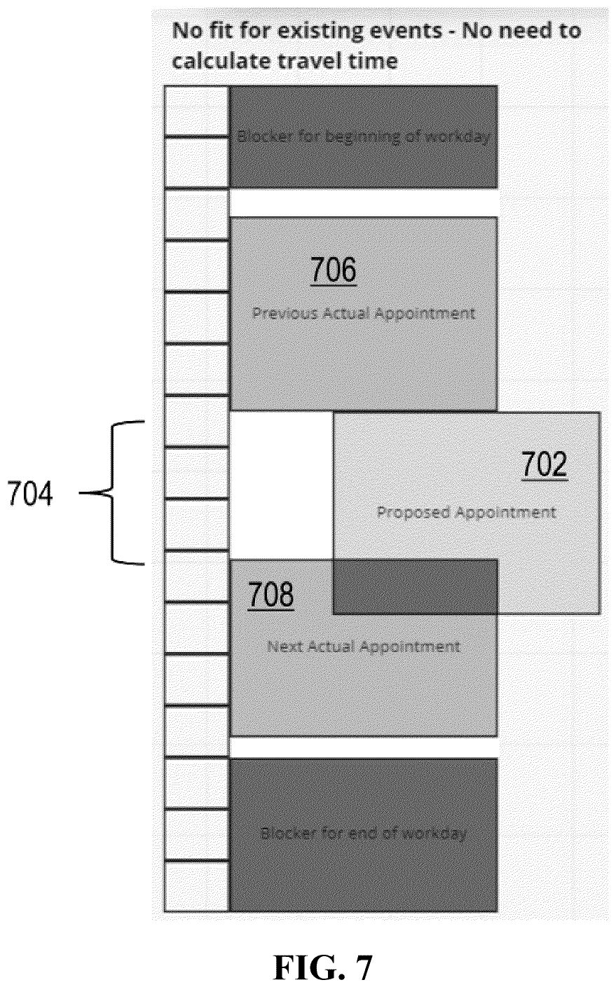

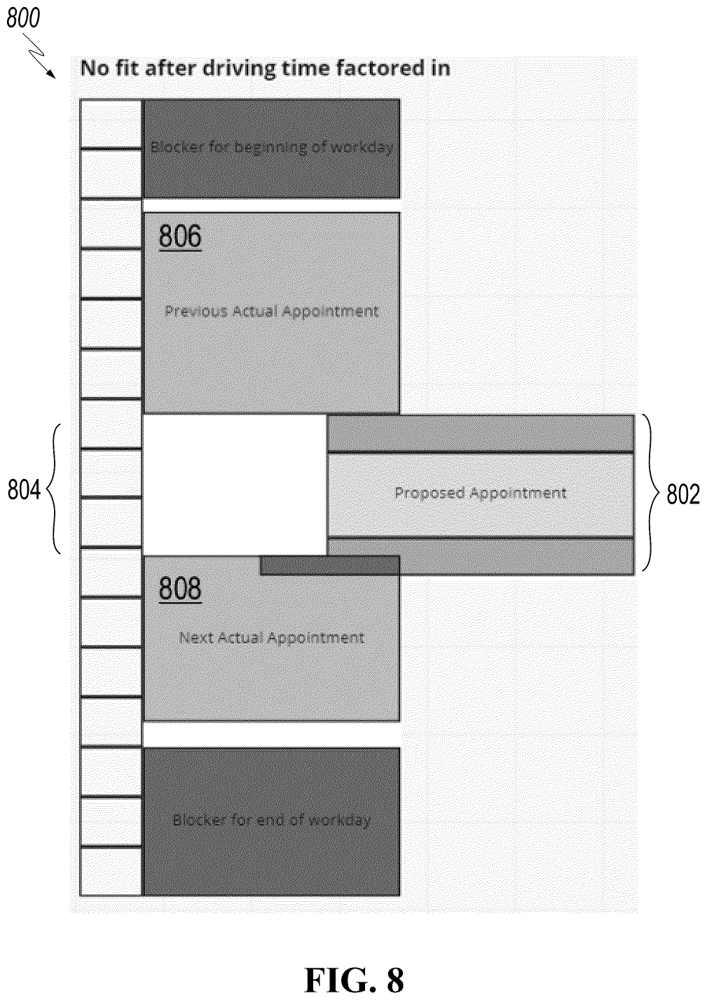

In some implementations, the estimated operation time can have a time duration greater than the time slot. As a result, the time slot can be deemed to be unsuitable for the target assignment and discarded. For example, the time slot can be discarded without calculating the travel time. FIG. 7 is an exemplary illustration of a proposed operation time 702 having a time duration greater than the time slot 704 temporally located between a previous appointment 706 and a following appointment 708. In some implementations, if the estimated operation time has a time duration less than the time slot, an estimated travel time to and from the target location can be calculated. If the comprehensive operation time that includes the estimated operation time and the estimated travel time has a time duration greater than the time slot, the time slot can be deemed to be unsuitable for the target assignment and discarded. FIG. 8 is an exemplary illustration of a proposed comprehensive operation time 802 having a time duration greater than the time slot 804 temporally located between a previous appointment 806 and a following appointment 808. If the time slot(s) associated with a service provider (e.g., first service provider) within the user's time frame for performing the target assignment does not accommodate the comprehensive operation time, the user can be notified that the service provider is incapable of performing the target assignment. Alternately, if the time slot(s) associated with a service provider (e.g., first service provider) can accommodate the comprehensive operation time, the user can be notified that the service provider is capable of performing the target assignment.

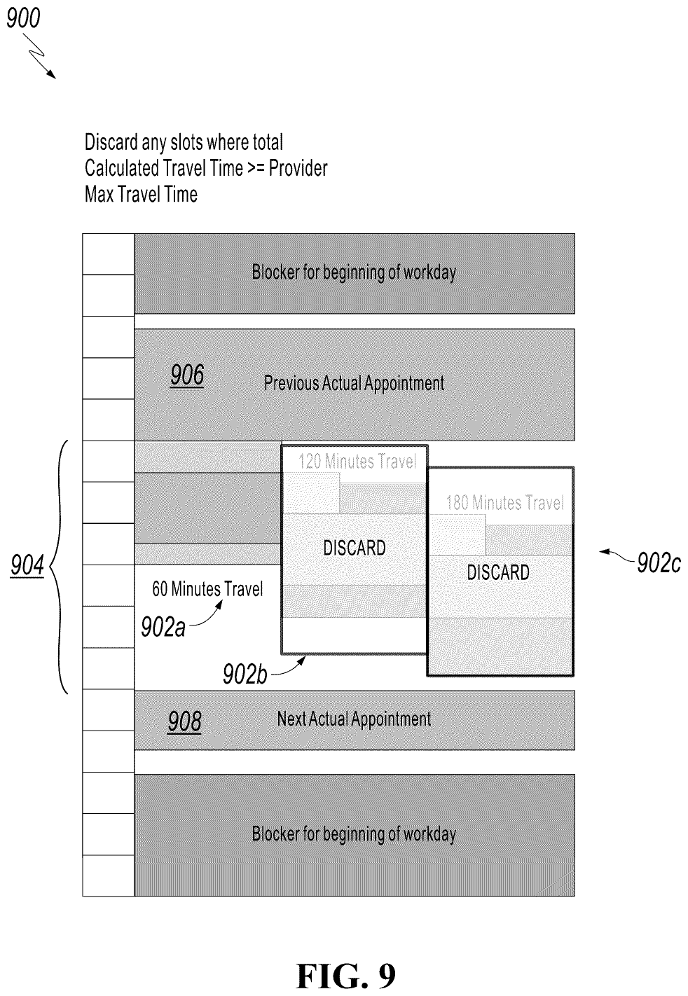

In some implementations, when multiple proposed comprehensive operation times are calculated for a given time slot, one or more of the proposed comprehensive operation time that have a travel time greater than a predetermined threshold travel time (e.g., included in the service provider preferences) can be discarded. FIG. 9 is an exemplary illustration of multiple proposals for comprehensive operation times for an available time slot. FIG. 9 illustrates that comprehensive operation times 902a, 902b and 902c are calculated for the time slot 904 that is temporally located between a previous appointment 906 and a following appointment 908. The travel time associated with the operation times 902a, 902b and 902c is 60 minutes, 120 minutes and 180 minutes, respectively. If the threshold travel time is set to 100 minutes, comprehensive operation times 902b and 902c can be discarded. Alternately, if the threshold travel time is set to 150 minutes comprehensive operation time 902c can be discarded. Alternately, if the threshold travel time is set to 200 minutes, none of the comprehensive operation times can be discarded.

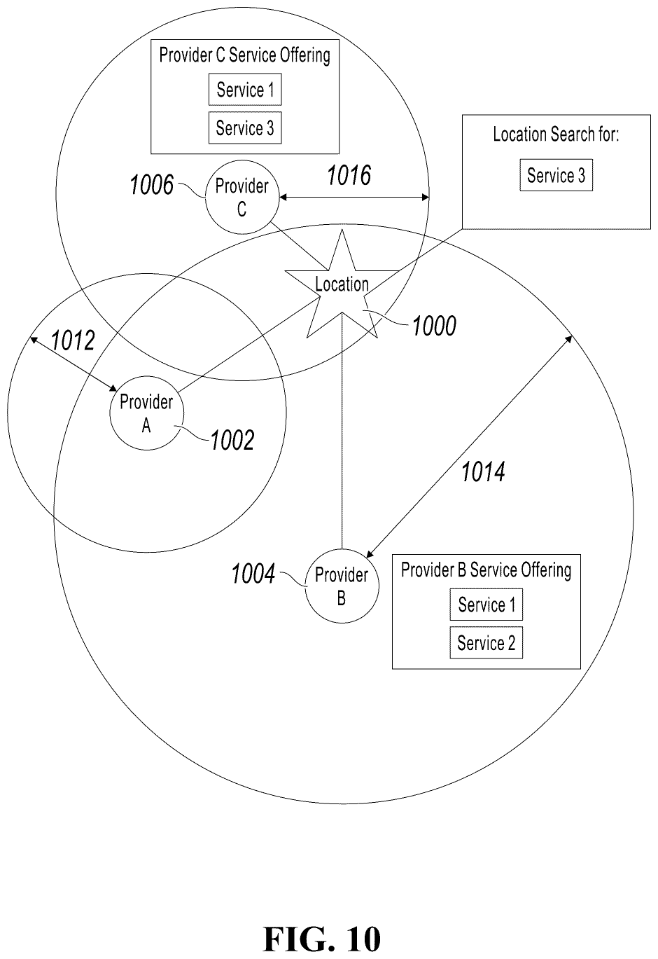

In some implementations, one or more service providers can be selected from available service providers prior to calculation of estimated travel time, estimated operation time, etc. The selection can be based on maximum travel distances associated with the service providers (e.g., included in the service preferences). FIG. 10 illustrates exemplary selection of service providers for a target location 1000 based on maximum travelling distances associated with the selection providers. As illustrated in FIG. 10, a first service provider 1002 has a first maximum travel distance 1012, a second service provider 1004 has a first maximum travel distance 1014, and a third service provider 1006 has a third maximum travel distance 1016. Because the distance between the first provider 1002 and the target location 1000 is greater than the first maximum travel distance 1012 of the first provider 1002, the first provider can be discarded. The service providers can be discarded based on the service that they are providing. In other words, service providers that do not provide the type of target assignment associated with location 1000 can be discarded. For example, if the target assignment type associated with location 1000 is “Service 3” and the second service provider 1004 provides services of types “Service 1” and “Service 2” but not “Service 3,” the second service provider 1004 can be discarded. In some implementations, if both maximum travel distance and target assignment type constraints are applied to FIG. 10, the first service provider 1002 and the second service provider 1004 can be discarded and information associated with the third service provider 1006 can be presented to the user associated with the target location 1000.

In some implementations, if multiple service providers have been selected based on the constraints (e.g., maximum travel distance, maximum travel time, target assignment type, etc.), the selected service providers can be ranked and the ranking can be presented to the user. For example, the selected service providers can be ranked based on rating, experience (e.g., total number of jobs), insurance information, tentative cost of performing the target assignment, proximity (e.g., travel distance), etc., associated with the selected service providers. In some implementations, the user can select the property for ranking the service providers.

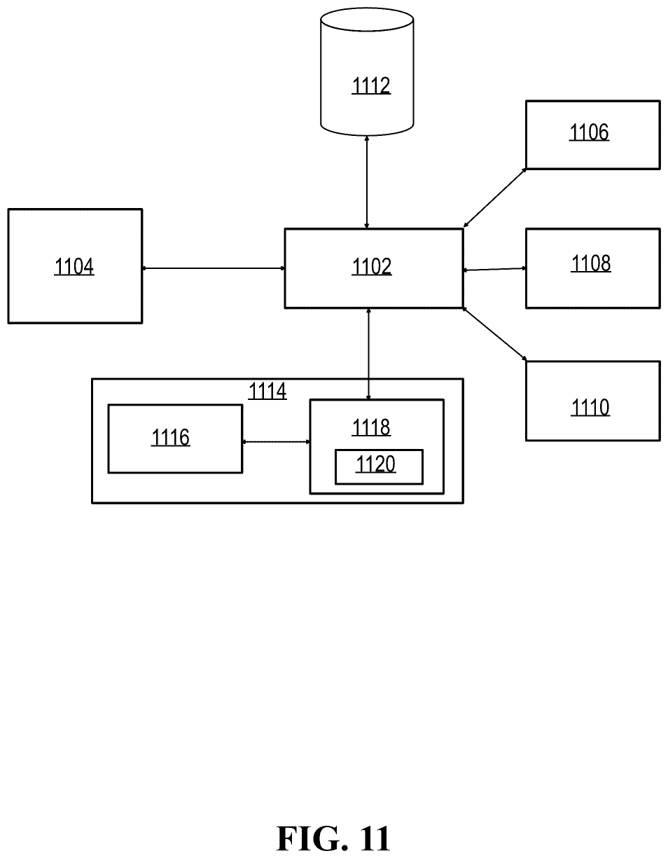

In some implementations, the methods described above (e.g., steps 102-108) can be implemented by a computing device (e.g., by a processor in a computing device). FIG. 11 illustrates an exemplary computation device 1102 for scheduling a service appointment. As illustrated in FIG. 11, the computing device 1102 can be in communication with a user's device 1104. In some implementation, the computing device 1102 can be a cloud-based service. The computing device 1102 can receive data from the user (e.g., data characterizing target assignment, target assignment type, target area, timeframe for scheduling the target assignment etc.), and provide scheduling information to the user (e.g., comprehensive operation time, estimated travel time, estimated operation time, operation cost, travel cost, etc.) to the user. In some implementations, the computing device 1102 can communicate with one or more service providers' devices 1106-1110. For example, the computing device 1102 can retrieve the calendar schedule of the service provider from the service providers' devices 1106-1110. In some implementation the calendar schedule of the service provider can be stored and hosted by the computing device 1102 (or a cloud-based service). For example, the calendar schedule can be stored in a database 1112 associated with the computing device 1102. The service providers can decide whether to use a third-party calendar service (from which the calendar schedule can be retrieved) or use a calendar service provided by the computing device 1102.

In some embodiments, the computing device 1102 can include a service provider portal that service providers can access to provide a schedule data or calendar data. In some embodiments, the service provider portal can include functionality configuring a service provider schedule data or calendar data. For example, the service provider portal can enable the ability to set filters and/or fees. In this way, service providers can personalize their appointment scheduling experience by setting filters and/or fees based on various factors such as appointment score (AS), combined travel time (CTT), excess combined travel time (ECT), combined travel factor (CTF), weighted efficiency score (WES), travel time before (T_{B}), travel time after (T_{A}), downtime before (D_{B}), downtime after (D_{A}), or the like. In some embodiments, filters can be used to conceal particular time slots from customers attempting to schedule the service provider.

In some embodiments, the service provider portal can include filters for the configuration of preferred windows for appointments, blocked periods of time in a work day during which appointments are preferably not scheduled, and thresholds associated with travel time and/or downtime. Filters can be configured using the system and methods herein for any parameters described herein, including but not limited to, travel times before and after, distance to and from a proposed appointment, downtime, an appointment score (AS), a weighted efficiency score (WES), route distance to and from a proposed appointment, as well as travel time to and from a proposed appointment. Filters can be set as tiers or hierarchically, such that a first filter can be applied to a set of service providers, and then within the bounds of the first filter, a second filter can be applied to time slots that resulted from application of the first filter. For example, the second filter can implement more granular or nuanced filtering such as actual driving distance to and from an appointment, AS, WES, downtime, or other travel parameters as described herein.

In some embodiments, service providers can filter calendar data via the service provider portal. For example, a service provider may filter a calendar to view appointments which occur outside of a previously determined preferred window set by the service provider. In this way, the service provider can adjust fees associated with those appointments which occur during windows of time which are not preferred (e.g., higher fees can be charged for services which occur during undesirable periods of time). In some embodiments, a service provider can filter proposed appointments having an AS above 50 or a predetermined AS value. In another embodiment, a service provider can filter proposed appointment to hide those appointments that have a CTT greater than 45 minutes or a predetermined CTT value. In some embodiments, the service provider can filter proposed appointments to hide those appointments which have a D_{B} greater than 60 minutes or a predetermined D_{B} value. Filters and predetermined filter threshold values used in the filters can be configured for any of AS, CTT, ECT, CTF, WES, T_{B}, T_{A}, D_{B}, D_{A} via the service provider portal.

The service provider can implement filters in a number of ways. In some embodiments, where a service provider can build a filter using conditional statements, like spreadsheet formulas, based on a desired filter parameter for available appointment time slot attributes such as distance to, distance from, travel before, travel after, AS, WEC, CTT, ETT, a proposed location, or components of an address or location. Appointment time slots that do not meet the service provider's filter settings will not be deemed valid and therefore are not shown to the booker.

The same methods can be used to set fees. Service providers can input conditions based on which their fees increase or decrease. For example, in one embodiment, a service provider can provide a list of zip codes that they will not provide service in or travel to. In another embodiment, the service provider can provide a list of zip codes which are associated or tagged to indicate a fee increase.

In one embodiment, the service provider portal can provide a sandbox or test area to input and evaluate filter and fee settings. For example, the service provider portal can provide an input interface and an output interface linked to the input interface. The input interface can include an input list of a variety of sample appointment time slots with different attributes, and an output list can display the results associated with the filters or fees and the input list. A filter/fee interface can operate in between the input interface and the output interface where the service providers can enter conditional filtering & fee input(s). As the provider adjusts these inputs, the output list is adjusted in real time factoring in filtered appointments and fees and displayed in the output interface.

In some embodiments, inputs for filter and fee settings can be provided via a natural language interface. A service provider can filter and adjust fees for appointment time slots based on natural language inputs. As an example, a service provider can set a filter by speaking, “Never show appointments in the afternoon unless the estimated service price is over $1000. Add $10 to each fee for time slots with zip code containing 02127. Never show time slots for waterfront properties when the tide is dropping below 3 feet”.

The service provider portal can also enable the configuration of fees, such as fee policies associated with appointment durations, travel times, and/or appointments occurring outside of normal business hours (e.g., outside of preferred windows of time). Fees can be configured to encourage customers to choose more efficient appointment time slots. In some embodiments, service providers can offer fee discounts as the service order price (excluding any fees) increases. Thus, service providers can configure fee discounts proportionate to service costs. For example, a service provider could set a discount threshold of $100, after which they offer a 5% discount on each additional predetermined increment (e.g., $50) of service fees. If a customer's order costs $200, they would receive a 10% discount on the fees associated with their service at a particular proposed appointment or appointment slot.

In some embodiments, service providers can configure fees so that an additional fee is charged for appointments that include more than 20 minutes of ECT or some other predetermined ECT value. The fee could include a flat fee and/or an additional fee per additional minute above the ECT threshold. In another embodiment, a service provider could configure and charge a fee based on D_{B} exceeding a 30 minute threshold and could include an additional fee per minute above the D_{B} threshold. In some embodiments, a service provider can configure and charge a fee for every 5 point increase in the WES score above a WES threshold value. Fees and predetermined fee threshold values used in fee policies can be configured for any of AS, CTT, ECT, CTF, WES, T_{B}, T_{A}, D_{B}, D_{A} via the service provider portal.

In some implementations, the database 1112 can store various information associated with the user and the service provider (e.g., service provider preferences, service providers' calendar schedule, etc.). The computing device 1102 can retrieve the aforementioned information from the database 1112 and store the computed information (e.g., comprehensive operation time, estimated travel time, estimated operation time, operation cost, travel cost, etc.) in the database 1112.

In some embodiments, the computing devices 1102 and/or 1104 be configured as conversational agents. In broad terms, conversational agents can interact directly with users via voice or text modalities. A conversational agent and a user can exchange information with each other in a series of steps to fulfill a specific goal or objective of the user. The exchange of information can form a dialog between the conversational agent and the user. Information supplied by the user during one or more steps of the dialog can be processed by a system in which the conversational agent is configured and deployed to provide contextually relevant outputs relating to each of the dialog steps. In this way, the system can generate statements and/or questions during the dialog with the user in a contextually accurate and efficient manner with regard to the specific goal or objective of the user.

Conversational agents can be utilized in scheduling applications to allow a user to interact with a scheduling service or service providers in regard to a service appointment without requiring a human support operator or dedicated human scheduling resource. Conversational agents can process data received in a variety of modalities, such as voice, text, and/or web site interactions. Conversational agents can also process data received from a variety of input devices, such as computing devices, which may for example display a website of a service provider or a scheduling service entity, a browser-enabled smartphone or mobile computing device, as well as intelligent or virtual personal assistant devices.

In some embodiments, the computing device 1102 can include functionality, such as an application programming interface (API) and associated data services, enabling conversational dialogues between a user and the scheduling services as described herein. For example, the computing device 1102 can be a frontend device communicating via an API with a backend device 1104. A user of computing device 1102 can enter queries or data associated with scheduling a service provider, which when received by a corresponding conversational agent or dialog generating functionality on the computing device 1104, can be processed to determine contextually appropriate responses that can be returned to the user of the computing device 1102. For example, in some embodiments, the computing device 1102 can include a graphical user interface (GUI) provided via a display of the computing device 1102. The GUI can be configured to provide a dialogue with the backend device 1104 in regard to scheduling services or service providers.

The computing device 1102 can include a plurality of applications configured thereon or therein. The applications can include conversational agent frontend functionality, such as APIs received from the computing device 1104 that can be incorporated into a website of the scheduling service provider to enable support for text and/or voice modalities via a customizable user interfaces configured on the computing device 1102. The applications can implement client APIs on different computing devices 1102 and web browsers in order to provide responsive multi-modal interactive graphical user interfaces (GUI) that are customized for a particular service provider. The GUI and applications can be provided based on a profile associated with the service provider. In this way, the conversational agents can provide customizable branded assets defining the look and feel of a user interface, different voices, as well as contextually relevant textual or voice responses generated by the computing device 1104 which are specific to the service provider.

The computing device 1104 can operate to receive dialog data, such as user scheduling queries provided to the computing device 1102 as part of a service provider scheduling dialog system that can be configured on the computing devices of FIG. 11. Responsive to receiving the dialog data from the computing device 1102, the computing device 1104 can process the dialog data to generate responses to the user provided dialog data. In some embodiments, the computing device 1104 can be a server device which can be located on-premises of a scheduling service provider or can be located remotely from the scheduling service provider. In some implementations, the service provider scheduling dialog system described herein can be implemented as a distributed architecture or a cloud computing architecture. In some implementations, one or more of the components or functionality included in the service provider scheduling dialog system can be configured in a microservices architecture. In some implementations, one or more components of the service provider scheduling dialog system can be provided via a cloud computing server of an infrastructure-as-a-service (IaaS) and be able to support a platform-as-a-service (PaaS) and software-as-a-service (SaaS) services.

The computing device 1104 can include a communications module to receive the computer-readable instructions and/or user data transmitted from the computing devices 1102, 1106, 1108, 1110 and/or the database 1112. The computing device 1104 can also include one or more processors configured to execute instructions that when executed cause the processors to perform natural language processing on the received dialog data and to generate contextually specific responses to the user dialog inputs using one or more interchangeable and configurable natural language processing resources which can be associated with a particular service provider. The computing device 1104 can also include a memory configured to store the computer-readable instructions and/or user data associated with processing user dialog data and generating dialog responses. The memory can store a plurality of profiles associated with each service provider or entity. The profile can configure one or more processing components of the service provider scheduling dialog system with respect to the entity or service provider for which the service provider scheduling dialog system has been configured.

In some embodiments, the service provider scheduling dialog system can include one or more subsystems. Each subsystem and the components or functionality configured therein can correspond to a particular service provider or service entity, that has been configured within the service provider scheduling dialog system to provide conversational agents to end users. For example, the service provider scheduling dialog system can include a first subsystem which can be associated with a first service provider, such as telecommunication company, and a second subsystem which can be associated with a second tenant, such as a real-estate firm. In this way, the service provider scheduling dialog system can be configured as a multi-provider portal to provide natural language processing for different service providers, and their corresponding conversational agent frontend applications, which can be configured on a variety of multi-modal digital endpoint computing devices 1104.

The subsystems can include components implementing functionality to receive user dialog data from a variety of multi-modal conversational agents and to generate dialog responses in the context of a particular lexicon of a service provider or service entity for which the service provider scheduling dialog system has been deployed. For example, in some embodiments, a subsystem can include speech recognition components, natural language agent components, text-to-speech synthesis components for generating audible data associated with dialog responses, and a plurality of service provider modules providing a specific vernacular, dialect, or contextual data which can be specifically associated with a particular service provider. In some implementations, the service provider scheduling dialog system can include one or more subsystems 130.

The service provider scheduling dialog system can also include a machine learning platform. Machine learning can refer to an application of artificial intelligence that automates the development of an analytical model by using algorithms that iteratively learn patterns from data without explicit indication of the data patterns. Machine learning can be used in pattern recognition, computer vision, email filtering and optical character recognition and enables the construction of algorithms or models that can accurately learn from data to predict outputs thereby making data-driven predictions or decisions.

The machine learning platform can include a number of components configured to generate one or more trained prediction models suitable for use in the service provider scheduling dialog system described herein. For example, during a machine learning process, a feature selector can provide a selected subset of features to a model trainer as inputs to a machine learning algorithm to generate one or more training models. A wide variety of machine learning algorithms can be selected for use including algorithms such as support vector regression, ordinary least squares regression (OLSR), linear regression, logistic regression, stepwise regression, multivariate adaptive regression splines (MARS), locally estimated scatterplot smoothing (LOESS), ordinal regression, Poisson regression, fast forest quantile regression, Bayesian linear regression, neural network regression, decision forest regression, boosted decision tree regression, artificial neural networks (ANN), Bayesian statistics, case-based reasoning, Gaussian process regression, inductive logic programming, learning automata, learning vector quantization, informal fuzzy networks, conditional random fields, genetic algorithms (GA), Information Theory, support vector machine (SVM), Averaged One-Dependence Estimators (AODE), Group method of data handling (GMDH), instance-based learning, lazy learning, Maximum Information Spanning Trees (MIST), and transfer learning methods based on pre-trained, generalized embeddings as well as domain-based embeddings. In some embodiments, the machine learning algorithm used herein can include large language models (LLM), generative pre-trained transformers (GPT), autoregressive language models, vector embeddings, or the like.

The service provider modules can be used in the machine learning process to train the classification algorithms included in the natural language components. The model trainer can evaluate the machine learning algorithm's prediction performance based on patterns in the received subset of features processed as training inputs and generates one or more new training models. The generated training models, e.g., classification algorithms and models included in the natural language components, are then capable of receiving user data including text strings or voice data corresponding to a user query and to output predicted textual or audible responses including at least one word from a lexicon associated with the service provider or service entity for which the service provider scheduling dialog system has been configured and deployed. In this way, the service provider scheduling dialog system can generate appointment scheduling dialogs in real-time for users with a number of different service providers.

As further shown in FIG. 11, in some embodiments, the scheduling service dialog system described herein can include one or more predictive models that can be trained in a machine learning process as generative dialog interfaces configured to receive input prompts from a user and to generate responses to the inputs. For example, as shown in FIG. 11, a dialog generator subsystem (DGS) 1114 can be communicatively coupled to computing device 1102. The DGS can receive inputs from a user of the computing device 1104 regarding scheduling a service provider and can determine an appropriate response in regard to the user's query or input. The DGS 1114 can include a response generator (RG) 1116 and a response configuration module (RCM) 1118.

The RG 1116 can include one or more predictive models configured to generate contextual responses in response to user inputs or queries. The RG 1116 can include a plurality of predictive models, each of which can be associated with a different service provider. Each service provider-specific predictive model can be trained in a machine learning process to generate response prompts that are specific to the services, appointment types, scheduling, and resources for a particular service provider.

The RCM 1118 can provide user input prompts to the RG 1116 and can monitor and evaluate responses generated by the RG 1116. The RCM 1118 can include functionality configured to edit responses generated by the RG 1116. In some embodiments, the RCM 1118 can request or otherwise cause the RG 1116 to re-generate a response provided by the RG 1116.

In some embodiments, the DGS 1114 can be configured within the computing device 1102. In some embodiments, the RCM 1118 can be located remotely from the computing device 1102 and/or the RG 1116. For example, the RCM 1118 can trigger a regeneration of a dialog response if it is determined that the response was incorrect or improper in regard to the user's input.

In some embodiments, the RCM 1118 can monitor and evaluate responses generated by the RG 1116 autonomously, for example using a rule set and/or one or more predictive models trained to evaluate the output of the RG 1116. In some embodiments, the RCM 1118 can be configured to evaluate and monitor responses generated by the RG 1116 via a human operator, such as in a human-in-the-loop (HIL) configuration. In this way, the human can monitor and evaluate the responses for clarity and contextual accuracy before passing them to the computing device 1102 and to the user via the computing device 1104. Incoming and outgoing messages can be monitored and evaluated using a response administration dashboard (RAD) 1120 that can be configured as a graphical user interface (GUI).

The RAD 1120 can receive and display messages between the user (via computing devices 1104 and 1102) and the RG 1116 in real time. The RAD 1120 can provide dialog data in a concise format to show user inputs or dialog responses and the responses generated by the RG 1116. For example, the RAD 1120 can provide the messages in a table format or spreadsheet that can include editable table entries or cells. The RAD 1120 enables a human operator to review and modify responses generated by the RG 1116 before being sent to the user.

The RAD 1120 can also include a message delay mechanism configured to pause the provision of responses generated by the RG 1116. In some embodiments, the RAD 1120 can include a message delay parameter, which can be configured by a user to delay sending a message for a period of time, such as 10 seconds. The message delay parameter can be a global parameter that can be set for every response generated by the RG 1116. The message delay parameter can be configured to delay messages for review by the HIL operator of the RAD 1120. During the duration of time associated with the message delay parameter, the HIL operator can pause the message from sending using one or more play controls that can be configured in the RAD 1120. The one or more play controls can include a play, pause, edit, regenerate, or delete controls. The play control can be a default setting and can automatically send responses from the RG 1116 after the message delay parameter. The pause control can hold or pause responses from the RG 1116 from being sent. The stop control can stop responses from being generated by the RG 1116.

While paused for sending the HIL operator can edit or modify the response generated by the RG 1116. Alternatively, while paused, the HIL operator can regenerate the response from the RG 1116. For example, if the RG 1116 mistakenly generated an inaccurate response, the HIL operator can cause the RG 1116 to regenerate a new response for review. Regeneration will automatically pause and repopulate the response. Once a message is successfully edited, the message delay parameter controls the sending of the message (e.g., after the amount of time associated with the message delay parameter has elapsed).

Advantageously, the HIL configuration of the DGS 1114 can provide improved, contextually accurate dialogs with a user in regard to one or more service providers and the scheduling thereof. By integrating human supervision and intervention, the system and methods herein can provide more robust dialogs with a user that are curated for a specific conversational goal or objective.

In some embodiments, the system and methods described herein can generate multiple proposed appointments for a period of available time by determining an appointment score (AS) by which the proposed appointments can be ranked for presentation to a user. This can be advantageous to provide users with multiple options for service appointments during the period of available time. The system and methods herein can optimize determination and provision of proposed appointments based on the AS by determining an amount of time to travel to a next appointment from a previous appointment (T_{B}), an amount to time to travel from a previous appointment to a next appointment (T_{A}), an amount of downtime before a next appointment (D_{B}), or an amount of downtime after a previous appointment (D_{A}). A ratio of before and after travel time (T_{R}) can be determined for T_{B} and T_{A}. A ratio of before and after distance (D_{R}) can be determined for D_{B} and D_{A}. The AS can be determined as T_{R}+D_{R}/2*100. In this way, the AS can be determined on a scale of 0-100 with the proposed appointment time having the highest AS ranked first and the proposed appointment time having the lowest AS ranked last. In some embodiments, the AS can be determined without computing a ratio and can be determined to be the minimum of T_{B}, T_{A}+the minimum of D_{B}, D_{A}.

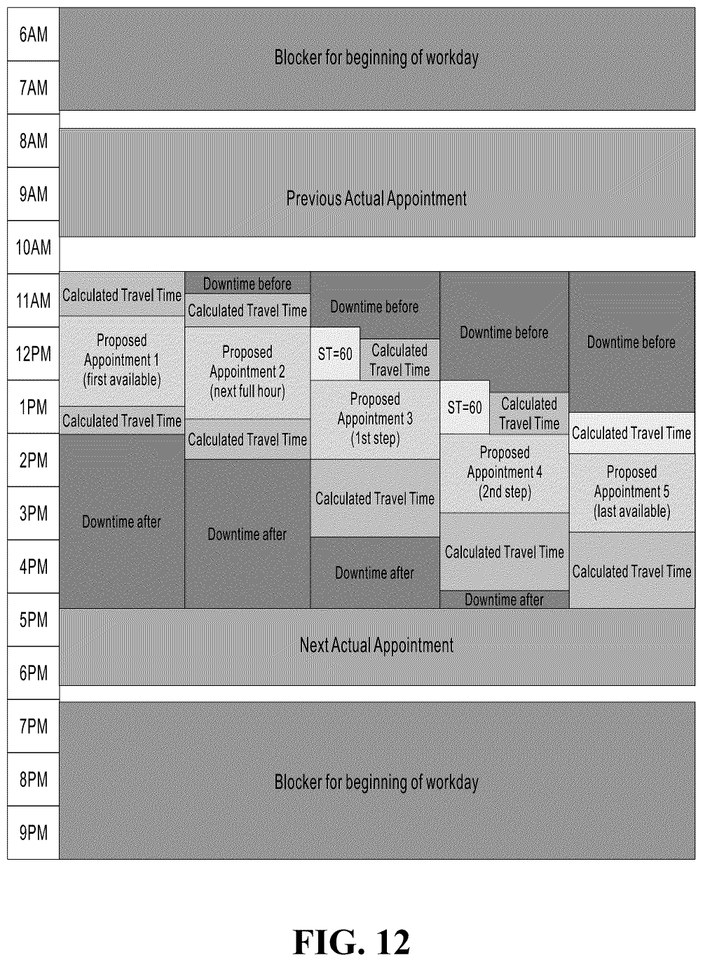

In this approach, time periods which have the highest AS can be ranked highest and can be provided to a user as a proposed appointment time period. For example, with reference to FIG. 12, the system and methods herein can determine an AS for time slots that are available between a previous appointment (e.g., the “previous actual appointment” ending at 11 AM) and a next appointment (e.g., the “next actual appointment” beginning at 515 PM). The system and methods herein can determine a number of proposed appointments (e.g., Proposed Appointments 1-5 shown in FIG. 12) based on determining an AS for each proposed appointment.

Responsive to a user input requesting or confirming a desired time frame to schedule an appointment, the system and methods herein can scan the desired time frame in the service providers calendar for any open time slots which occur within the user's desired time frame. An open time slot can be characterized by a previous event and a following event, such that the time period in between the previous event and the following event is unscheduled and available for scheduling. The previous event can be an appointment found in the service providers calendar with a confirmed address or an event that can be automatically generated by the system and methods herein as an event beginning a workday or an event ending a work day for a service providers home address. The available time slots can be optimized by removing any time slots that occur on non-business days for the service provider (e.g., days the service provider is closed for operation/business). Additionally, or alternatively, any time slots that are too short for the desired service or appointment length (including a buffer time before or after as required by the service provider).

The system and methods herein can further determine location data (e.g., geocode) all locations associated with the service provider, the user, as well as the locations of adjacent appointments occurring before or after a proposed time slot. For example, the system and methods herein can determine location data associated with the appointment location, the service providers home address, as well as addresses included in the service providers calendar which may be adjacent to a desired time slot or proposed appointment time. Based on the location data, the system and methods herein can determine driving times for all available time periods. For example, a driving time from a previous event or appointment to a proposed appointment can be determined. Additionally, a driving time from a proposed appointment to a next event or appointment can also be determined. Based on determining the driving times, proposed time slots can be discarded for which the amount of time for the proposed time slot, the driving time (before or after), and any downtime (before or after) in combination exceed the duration of the available time slot. Applying these heuristics, the system and methods herein can advantageously provide an efficient, accurate, and timely response for determination of available time slots suitable for proposed appointment times. This can enable the system and methods herein to respond rapidly to a large number of appointment time queries simultaneously and in parallel for a large number of different service providers.

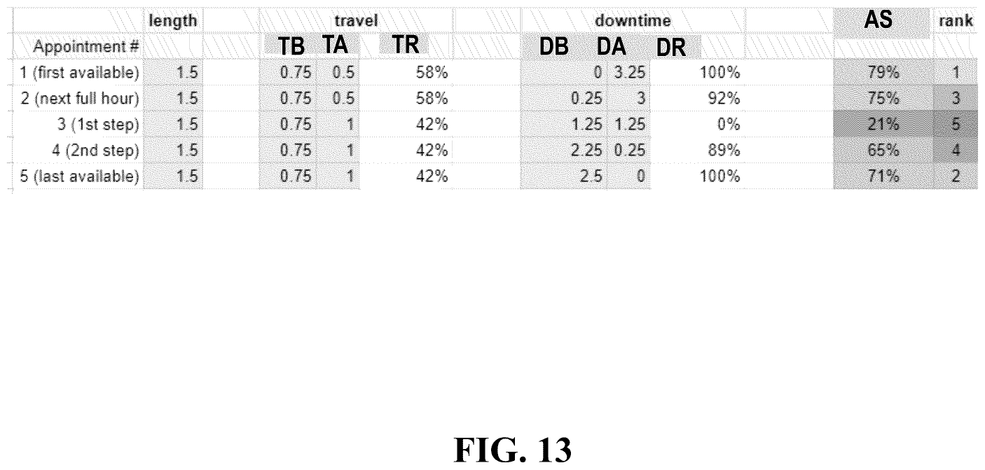

FIGS. 12 and 13 illustrate how the AS is used to determine and rank proposed appointment times by the system and methods herein. As shown in FIG. 12, an available time slot exists between 11 AM and 515 PM. Five different proposed appointments (e.g., Proposed Appointments 1-5) have been determined including the requisite travel time before and/or after, downtime before and/or after, and step times (e.g., ST=60 associated with Proposed Appointments 3 and 4). As shown in FIG. 13, the data used to determine the AS for each of the proposed time slots 1-5 is shown. The amount of travel time before (T_{B}) and after (T_{A}) a proposed appointment time can be used to determine a ratio of travel time (T_{R}). The amount of downtime before (D_{B}) and after (D_{A}) a proposed appointment time can be used to determine a ratio of downtime (D_{R}). The AS can be determined as the sum of the T_{R} and D_{R}/2*100 for a proposed appointment time.

As shown in FIG. 13 (and referring to the data values shown in FIG. 12), the first proposed appointment (e.g., Proposed Appointment 1 starting at 1145 AM) has the highest AS and is thus ranked first. The fifth proposed appointment (e.g., Proposed Appointment 5 starting at 215 PM) is ranked second. The second and fourth proposed appointments (e.g., Proposed Appointment 2 starting at 12 PM and Proposed Appointment 4 starting at 2 PM) are ranked third and fourth, respectively. The third proposed appointment (e.g., Proposed Appointment 3 starting at 1 PM) is the lowest ranking proposed appointment.

In some embodiments, proposed appointments can be generated using a weighted efficiency score (WES). The WES can provide a more balanced and efficient means of scheduling (e.g., generating proposed) appointments. The WES can be based on an AS determined for a proposed appointment and can further account for an amount of travel time related to the proposed appointment, such as an amount of combined travel time (e.g., an amount of travel time before an appointment (T_{B}) and an amount of travel time after an appointment (T_{A}). The WES can be further based on a measure of additional combined travel time identified as excess combined travel (ECT). Service providers can modify the significance of combined travel time used in determining a WES by virtue of a combined travel factor (CTF) which will be described further. A lower WES can indicate a more efficient appointment time slot and a higher WES can indicate a less efficient appointment time slot.

When computing a WES for a proposed appointment, the AS can be determined according to equation 1 below:

$$AS = min ( {T}_{B} , {T}_{A} ) + min ( {D}_{B} , {D}_{A} ) \qquad ( 1 )$$

In this embodiment, the AS can be a metric used to prioritize proposed appointments in regard to a minimal amount of travel time before (T_{B}) and after (T_{A}) and a minimum amount of downtime before (D_{B}) and after (D_{A}) an appointment. In this approach, a lower AS can indicate a more efficient appointment time slot in regard to minimal travel time and downtime.

ECT can indicate the amount of additional travel time for a given appointment slot compared to an appointment slot with the least combined travel time in a set of proposed appointments or appointment slots. For example, if one appointment slot has 10 minutes of combined travel time (CTT) e.g., T_{B}+T_{A} compared to another appointment slot with 0 minutes of combined travel time, the ECT would be 10 minutes. In some embodiments, CTT can be substituted for ECT to compute a WES for a proposed appointment slot. For example, ECT can require a set of proposed appointments in order to perform a comparison of one proposed appointment relative to a second proposed appointment with the least combined travel time. In some circumstances, a set of proposed appointments may not be available. In such cases, using the CTT and adjusting the CTF can generate similar WES results. In such cases, the total travel time (e.g., CTT) for a proposed appointment could be used in place of the ECT. In other words, ECT can be a more user-friendly parameter for user-facing scheduling interfaces.

CTF is a user-defined variable, that acts as a multiplier, to provide adjustment of the significance of CTT in WES determination. By default, CTF is set to 0.5 but can be adjusted based on preferences of the service provider. A CTF of 0 would default to the AS score (e.g., the proposed appointment having the least amount of travel and downtime on at least one side of the proposed appointment). Increasing the CTF value would downgrade appointments with longer CTT in ranking (even if it resulted in longer downtimes between appointments or longer travel times). The magnitude of the selected CTF can act to prioritize appointments with less combined travel time CTT (e.g., T_{B}+T_{A}).

The WES can be computed based on the above description of its parameters according to equation 2 below:

$$WES = AS + ( CTF * ECT ) \qquad ( 2 )$$

In some embodiments, A lower WES can indicate a more efficient appointment time slot for a proposed appointment. The WES enables a more adaptable, configurable, and efficient method for determining proposed appointments by accounting for both AS and CTT. By adjusting the CTF, preferences for shorter travel times (versus minimizing downtime, for example) can be easily configured by service providers using the system and methods described herein.

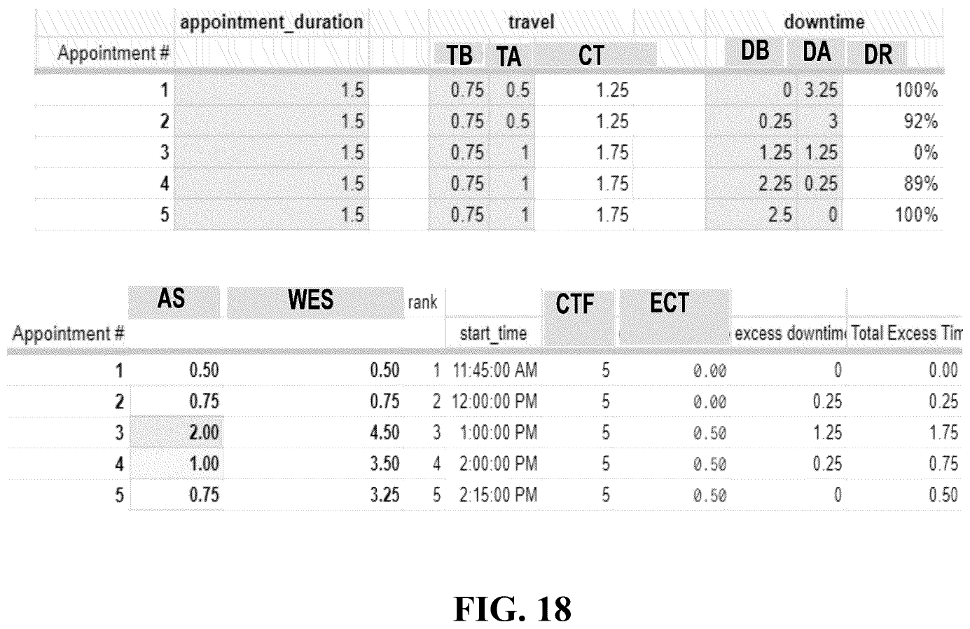

Referring back to the set of proposed appointments 1-5 shown in FIG. 12, the tables shown in FIG. 18 illustrate determination of WES and resulting rankings of the appointments 1-5. As seen, based on a CTF of 5, the appointments are ranked from most efficient (appointment 1) to least efficient (appointment 5).

In some embodiments, the system and method herein can be configured to apply and utilize an anchor parameter for determining a preferred window for generating one or more proposed appointments as described herein. The preferred window can include a start time anchor parameter and an end time anchor parameter. For example, if a service provider wished to schedule appointments during a preferred window of 9 AM to 11 AM, a first (start time) anchor parameter could be provided identifying 9 AM as the starting time of the preferred window and a second (end time) anchor parameter could be provided identifying 11 AM as the ending time of the preferred window. Service providers can configure a preferred window (and the corresponding anchor parameters) via the service provider portal described in relation to FIG. 11. Preferred windows (and the corresponding anchor parameters) can be input via a calendar configuration file, drag and drop, or manually entered at specific times on the service provider calendar.

An anchor parameter can be associated with an event or non-event which may occur throughout a day. The anchor parameter can define a time or a duration of time before or after which downtime will be zero or minimized. In this way, a time associated with an anchor parameter can be a border in a schedule by which downtime can be calculated (and minimized) for scheduling of proposed appointments. An anchor parameter can be associated with a blocking event or a blocking non-event. An anchor parameter can define a blocked time or a blocked duration of time. For example, an anchor parameter can be associated with a daily starting time from which appointments can be scheduled, a daily end time after which appointments should not be scheduled, or an existing appointment.

The amount of time from an anchor parameter can be used for determining an AS for a proposed appointment as described above in relation to utilizing the minimum of travel before and after the appointment as well as downtime before and after the appointment.

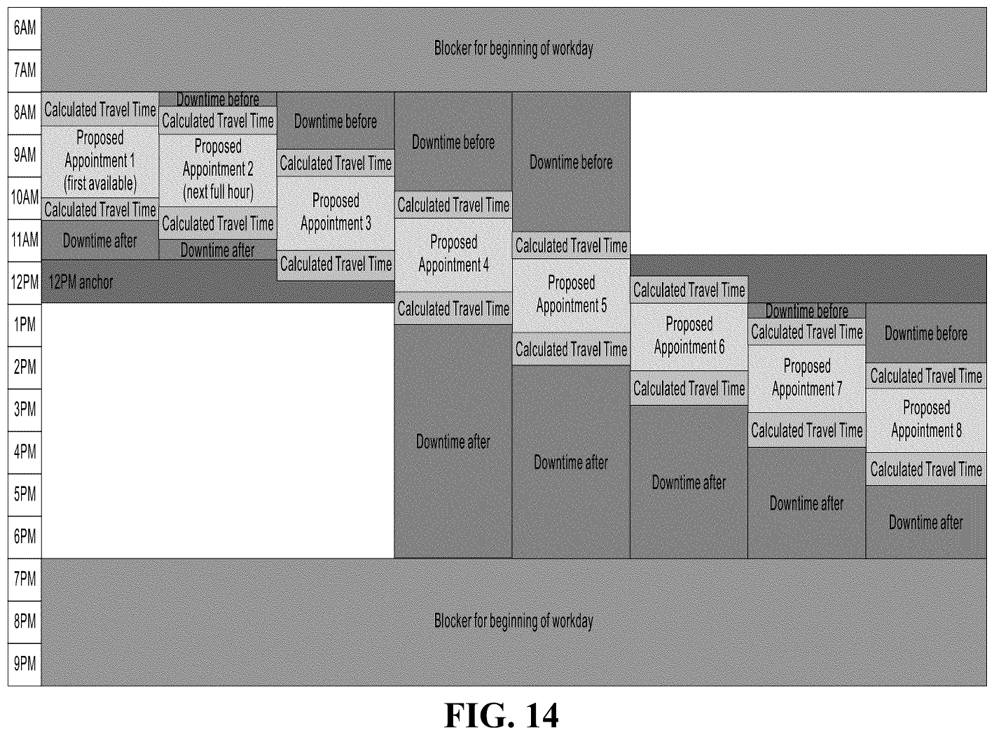

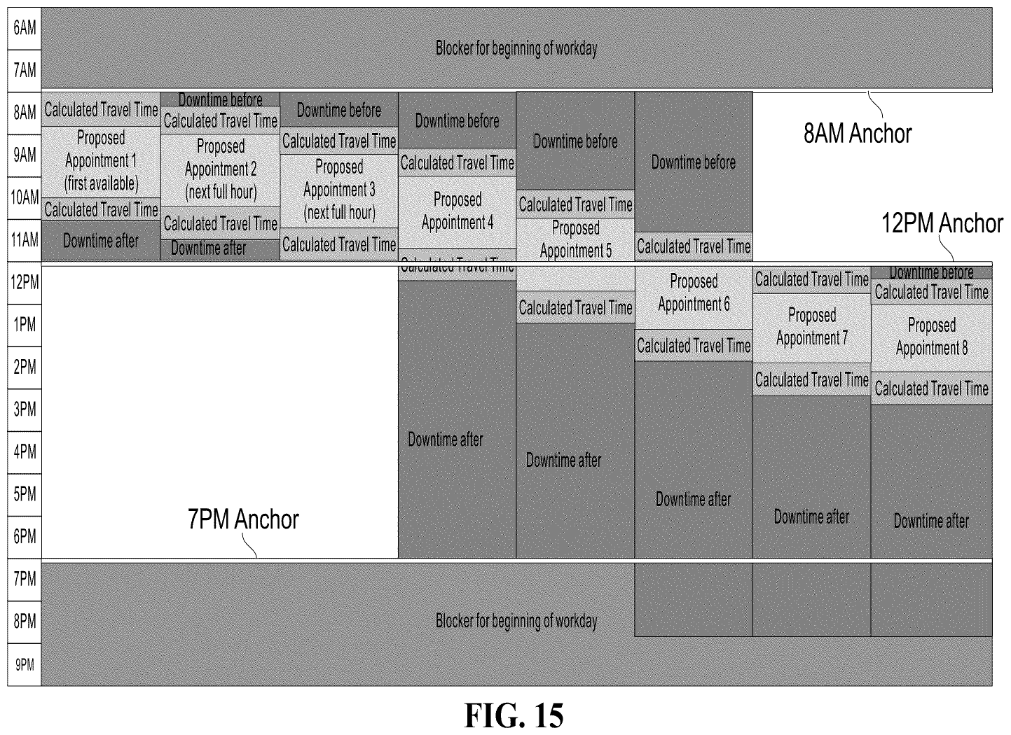

With reference to FIG. 14, an example timeframe is illustrated that includes a first blocked event from 6 AM-8 AM that is associated with the beginning of the workday. A second blocked event is shown from 7 PM-10 PM. Thus, the system and methods herein will only generate proposed appointment times between the hours of 8 AM and 7 PM. In this way, two preferred windows of time are created during which proposed appointments may be generated by the systems and methods described herein. A first preferred window can be between 8 AM and 12 PM and a second preferred window can be between 12 PM and 7 PM. As shown in FIG. 15, based on the aforementioned blocking events (e.g., the beginning of the workday and the end of the workday) a first anchor parameter can be set for 8 AM and a second anchor parameter can be set for 7 PM. A third anchor parameter can be set for 12 PM.

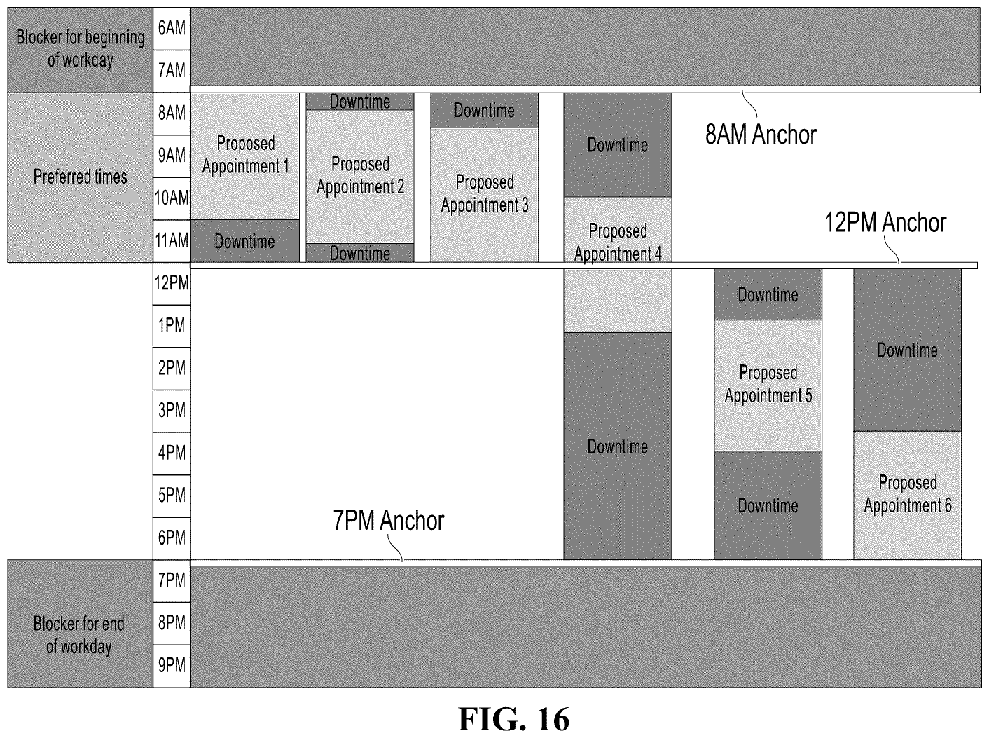

The system and methods herein can utilize the anchor parameters to determine proposed appointments. For example, as shown in FIG. 16, based on the anchor parameters described in relation to FIG. 15, the system and methods herein can generate proposed appointments (e.g., Proposed Appointments 1-6 as shown in FIG. 16. For simplicity, the before and after travel times have been included in the appointment time. The proposed appointments 1-6 are generated in regard to the preferred windows associated with the anchor parameters (e.g., the first preferred window associated with the first anchor parameter, the 8 AM anchor parameter, and the third anchor parameter, the 12 PM anchor parameter). As shown in FIG. 16, proposed appointments 1-3 can be generated as the most suitable (e.g., having the highest ranked AS) to occur within the first preferred window occurring between the first anchor parameter and the third anchor parameter so that there is minimal downtime after each proposed appointment. Proposed appointments 4-6 are increasingly less suitable (e.g., each having lower ranked AS and increasing amounts of downtime as compared to the proposed appointments 1-3), with the proposed appointment 6 being least suitable.

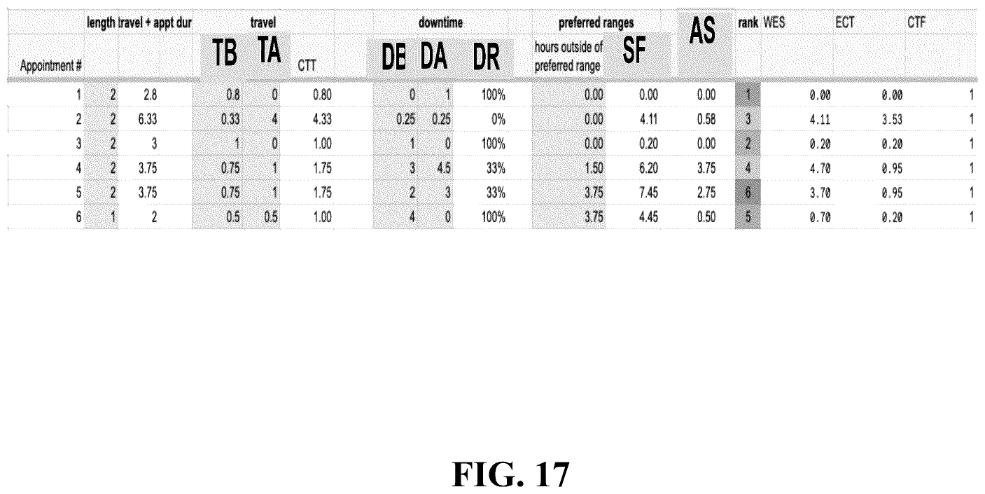

With reference to FIG. 17, the ranking of the proposed appointments can be seen in more detail. As described above with reference to FIGS. 12 and 13 for determining an AS for proposed appointments, the first and third proposed appointments can be ranked first and second respectively, while the second proposed appointment can be ranked second. Thus, the proposed appointments 1-3 can be determined to be most suitable as occurring with the first preferred window of time occurring between the first and third anchor parameters (e.g., the first anchor parameter at 8 AM and the third anchor parameter at 12 PM). Based on the anchor parameters associated with a preferred window, a suitability factor (SF) can be determined to identify a measure of suitability that a proposed appointment will occur during a preferred window based on an amount of the proposed appointment duration that will occur outside of the preferred window (e.g., the preferred range). For example, the SF can be determined based on Equation 3 shown below:

$$SF = ( hours outside of a preferred range + WES ) \qquad ( 3 )$$

In this way, a lower SF value will indicate an appointment that is more favorable. Referring to FIG. 17, the SF associated with the proposed appointments 1-3 is lower than the SF associated with appointments 4-6. Even though a proposed appointment may have a lower AS, for example proposed appointment 5 having a AS of 0.50, that appointment can be ranked lower because of having a higher SF (e.g., 4.45).

As further shown in FIG. 17, proposed appointments 4-6 are ranked lower because they have a higher SF and further because they include more hours outside of the preferred first window than appointment 1-3. For example, as shown, the fourth proposed appointment is ranked fourth because only 1.5 hours of its duration occur outside of the preferred first window, while the fifth and sixth proposed appointments include 3.75 hours of time outside of the preferred first window and thus have a lower SF. Thus, the more time that a proposed appointment includes outside of the preferred window, the higher the SF will be.

Certain exemplary embodiments are described herein to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
providing, by a data processor of a multi-provider scheduling platform, at least one conversational agent configured to receive query inputs and generate response outputs associated with scheduling target assignments performed by at least one service provider;
receiving, by the data processor, first data characterizing a query input provided to the at least one conversational agent, the query input including a request for at least one service provider to perform target assignment at a target assignment time;
determining, by the data processor, second data characterizing a response output contextually relevant to the query input, the response output including one or more appointments corresponding to the target assignment and the target assignment time; and
providing, by the data processor, the response output including the one or more appointments to the conversational agent.

2. The method of claim 1, wherein the conversational agent includes a natural language interface configured to receive the query inputs and generate the response outputs in audible format.

3. The method of claim 1, wherein the multi-provider scheduling platform includes a plurality of conversational agents, each conversational agent associated with a respective service provider of a plurality of service providers configured in the multi-provider scheduling platform and configured to generate contextually relevant response outputs based on the respective service provider and the query input.

4. The method of claim 1, wherein the at least one conversational agent is configured to generate response outputs based on a predictive model associated with the at least one service provider, the predictive model trained in a machine learning process using training data including one or more of target assignment types performed by the at least one service provider, schedule data associated with the at least one service provider, and resources associated with the at least one service provider.

5. The method of claim 1, wherein determining the response output further comprises determining the one or more appointments based on an appointment score determined for respective appointments of the one or more appointments, the appointment score determined based at least on a first ratio of a travel time before the respective appointment and a travel time after the respective appointment and a second ratio of a travel distance before the respective appointment and a travel distance after the respective appointment, and providing the response output including a ranked list of the one or more appointments based on the determined appointment score.

6. The method of claim 5, wherein determining the appointment score further comprises determining a weighted efficiency score for respective appointments of the one or more appointments, the weighted efficiency score determined based on a combined travel time for the respective appointment compared to a combined travel time for a second appointment of the one or more appointments, the weighted efficiency score further determined based on a combined travel factor provided by the at least one service provider and configured to prioritize the respective appointment having a lower combined travel time compared to the second appointment.

7. The method of claim 1, wherein determining the response output further comprises determining the one or more appointments based on an anchor parameter defining a window of time between a start time or an end time in which the one or more appointments can be scheduled and for which an amount of downtime before or after the one or more appointments is minimized.

8. The method of claim 7, wherein the anchor parameter corresponds to a blocking event, a non-blocking event, a daily start time, a daily end time, or a previously scheduled appointment.

9. The method of claim 7, wherein determining the response output further comprises determining the one or more appointments based on the anchor parameter and a suitability factor corresponding to a likelihood the respective appointment will occur within the window of time defined by the anchor parameter.

10. The method of claim 9, wherein the suitability factor is be determined as a function of an amount of time a portion of the respective appointment will occur outside the window of time defined by the anchor parameter and a combined travel time for the respective appointment compared to a combined travel time for a second appointment of the one or more appointments.

11. A system comprising:
at least one data processor of a multi-provider scheduling platform;
a memory coupled to the at least one data processor, the memory storing instructions to cause the at least one data processor to perform operations comprising:
providing at least one conversational agent configured to receive query inputs and generate response outputs associated with scheduling target assignments performed by at least one service provider;
receiving first data characterizing a query input provided to the at least one conversational agent, the query input including a request for at least one service provider to perform target assignment at a target assignment time;
determining second data characterizing a response output contextually relevant to the query input, the response output including one or more appointments corresponding to the target assignment and the target assignment time; and
providing the response output including the one or more appointments to the conversational agent.

12. The system of claim 11, wherein the conversational agent includes a natural language interface configured to receive the query inputs and generate the response outputs in audible format.

13. The system of claim 11, wherein the multi-provider scheduling platform includes a plurality of conversational agents, each conversational agent associated with a respective service provider of a plurality of service providers configured in the multi-provider scheduling platform and configured to generate contextually relevant response outputs based on the respective service provider and the query input.

14. The system of claim 11, wherein the at least one conversational agent is configured to generate response outputs based on a predictive model associated with the at least one service provider, the predictive model trained in a machine learning process using training data including one or more of target assignment types performed by the at least one service provider, schedule data associated with the at least one service provider, and resources associated with the at least one service provider.

15. The system of claim 11, wherein determining the response output further comprises determining the one or more appointments based on an appointment score determined for respective appointments of the one or more appointments, the appointment score determined based at least on a first ratio of a travel time before the respective appointment and a travel time after the respective appointment and a second ratio of a travel distance before the respective appointment and a travel distance after the respective appointment, and providing the response output including a ranked list of the one or more appointments based on the determined appointment score.

16. The system of claim 15, wherein determining the appointment score further comprises determining a weighted efficiency score for respective appointments of the one or more appointments, the weighted efficiency score determined based on a combined travel time for the respective appointment compared to a combined travel time for a second appointment of the one or more appointments, the weighted efficiency score further determined based on a combined travel factor provided by the at least one service provider and configured to prioritize the respective appointment having a lower combined travel time compared to the second appointment.

17. The system of claim 11, wherein determining the response output further comprises determining the one or more appointments based on an anchor parameter defining a window of time between a start time or an end time in which the one or more appointments can be scheduled and for which an amount of downtime before or after the one or more appointments is minimized.

18. The system of claim 17, wherein the anchor parameter corresponds to a blocking event, a non-blocking event, a daily start time, a daily end time, or a previously scheduled appointment.

19. The system of claim 17, wherein determining the response output further comprises determining the one or more appointments based on the anchor parameter and a suitability factor corresponding to a likelihood the respective appointment will occur within the window of time defined by the anchor parameter.

20. The system of claim 19, wherein the suitability factor is determined as a function of an amount of time a portion of the respective appointment will occur outside the window of time defined by the anchor parameter and a combined travel time for the respective appointment compared to a combined travel time for a second appointment of the one or more appointments.
